(19) United States
(12) Patent Application Publication
(10) Pub. No.: US 2007/0065589 A1
(43) Pub. Date: Mar. 22, 2007

(54) METHOD FOR THE PASSIVATION OF THE SURFACE OF COATED METAL BANDS AND DEVICE FOR THE APPLICATION OF THE PASSIVE LAYER ON A METAL COATED STEEL BAND

(76) Inventor: Theodor FLORIAN, Neuwied (DE)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/532,138

(22) Filed: Sep. 15, 2006

(30) Foreign Application Priority Data
Sep. 21, 2005 (DE) 102005045034.2-45

(51) Int. Cl. B05D 3/12; B05D 3/02; B05D 1/02; B05B 5/025

(52) U.S. Cl. 427/365; 427/421.1; 427/372.2; 118/620

(57) ABSTRACT

The invention provides a method for the passivation of the surface of metal bands covered with a coating, particularly tin-coated steel bands (S), which move at a band speed (v) through a coating installation. To allow an efficient passivation of the metal band surface even at high band speeds and simultaneously the lubrication of the coated metal band surface, after the coating process has been completed, an aqueous solution of a surface active substance is sprayed onto the coated metal band that moves at band speed (v). The invention further provides a device for the application of a metal coating on a steel band, particularly in a band tin-coating installation, as well as to the use of substances for lubrication and/or passivation during the manufacture of tin-coated steel bands, which can be sprayed as an aqueous solution on the tin-coated steel band.

### FIELD OF THE INVENTION

The invention relates to a method for the passivation of the surface of metal bands covered with a coating, particularly tin-coated steel bands, which are moved at a given band speed through a coating installation, as well as to a device for the application of the passive layer on a metal coated steel band, particularly in a band tin-coating installation. Furthermore, the invention relates to the use of a substance as a lubrication and/or passivation agent in the manufacture of tin-coated steel bands.

### BACKGROUND OF THE INVENTION

In the manufacture of tinplate, particularly in electrolytically operated band tin-coating installations, the coated steel plate (tinplate with tin metal and chromium metal+chromium(III) hydroxide) is passivated chemically or electrochemically, and then greased to render the coated steel plate resistant to oxidation and to lower the coefficient of friction, to allow the coated steel plate to be processed more easily in the subsequent processing. The passivation is usually carried out using Cr⁶⁺ containing solutions. In the state of the art, Cr⁶⁺-free passivation solutions have also been proposed, for example, in DE 42 05 819-A, DE 44 03 876-A, EP 0 932 453-A, EP 01 002 143-A, EP 01 015 662-A, WO 99/67444-A, WO 00/46312-A and EP 01 270 764-A. These publications for the most part focus on the passivation of aluminum- and zinc-containing surfaces of hot dip galvanized thin sheets and other hot dip galvanized steel parts for use in the automobile industry, and, to a small extent on the chromate-free passivation of tinplate.

However, when using coated metals for the manufacture of food containers, the requirements for the mentioned materials, in comparison to their use in the automobile industry, are different in terms of resistance to oxidation and thus passivation of the metal surface. The passivation must prevent particularly an excessive growth of the tin oxide layer during the storage of the food containers, which can lead to lacquering or to the consumption of the preserved material. Furthermore, the coated metal surface can be unpleasantly discolored as a result of a matte coloration or gold coloration, which can give the consumer the impression that the filled material is spoiled. In addition, the passivation must ensure the resistance of the metal container after it has been filled with food against the acids contained in the food, such as, for example, mercapto-amino-carboxylic acid anions, such as, cysteine and methionine. Such acid anions in the filled material can cause a delamination of the inner lacquer of the container, if the passivation is insufficient.

In the usual manufacture of tinplate in band tin-coating installations, after the tin coating and melting, the finest metal plate is quenched in a first water bath, then passivated in a chromate solution, and finally rinsed and dried thermally with fully desalted water. Next, an electrostatic lubrication is carried out with dioctyl sebacate (DOS) or acetyltributyl citrate (ATBC). The chromate adsorbed on the tinplate surface is reduced to Cr3+ by reacting with the ═Sn═O and ═Sn—OH groups of the tin surface, and, partially also to chromium metal, in the case of an electrochemical cathodic passivation. The Cr³⁺ precipitates as Cr³⁺ hydroxide. The passive layer, after the rinsing and drying of the tinplate surface, no longer contains Cr⁶⁺ ions.

Given the above, an objective of the invention is to provide a method and a device for the passivation of the surface of metal bands that have been covered with a coating, particularly of tin-coated steel bands, which are moved at a band speed through a coating installation, which are such that an efficient passivation of the metal band surface is possible even at high band speeds. In addition, simultaneously with the passivation of the metal band surface, a lubrication step is to be carried out, so that an additional subsequent treatment step to lower the coefficient of friction of the coated metal band surface becomes unnecessary. An objective of the invention also includes providing products for the passivation and/or lubrication of the surface of coated metal bands, which products can be used in the method according to the invention.

### SUMMARY OF THE INVENTION

These objectives are obtained by a method for the passivation of the surface of metal bands, a device for the application of a metallic coating on a steel band, and by substances for use as lubrication and/or passivation agents in the manufacture of tin-coated steel bands.

According to the method of the invention for the passivation of the surface of metal bands which are covered with a metal coating, after the tin deposition onto the metal band that moves through the coating installation, an aqueous solution of a surface active substance is sprayed on. It is preferable to squeeze out and evaporate to dryness the aqueous solution of the surface active substance using squeezing rolls. After squeezing and drying, only a thin film of the surface active substance remains on the surface of the coated metal band, where the overlay of this thin film as a rule is 2-15 mg/m². The surface active substances can be a siloxane, particularly a polymethyl siloxane or a polyethylene oxide-containing siloxane. Alternatively, it can be a copolymer, particularly an acrylate copolymer. The surface active substance is preferably sprayed through pipes, which are arranged at a separation from the coated metal band surface, and which have bores through which the aqueous solution reaches the coated metal band surface. It is preferred that at least one pipe with such bores be arranged on each side of the metal band to spray both sides of the metal band with the surface active substance.

The substances of the present invention have been shown to be particularly well suited for use as surface active substances. With these substances, the tin oxide growth on the coated metal band surface can be strongly reduced. In the treatment according to the invention of the metal band surface with these substances, there is a simultaneous decrease of the coefficient of friction of the metal band surface so treated to such low values that a subsequent lubrication with DOS can be omitted. The metal band surfaces that have been treated according to the invention have been shown to lend themselves well for lacquering. The substances of the present invention are particularly appropriate for use in the method according to the invention because they present/include a sufficient solubility in water without the addition of an organic solvent, and therefore can be sprayed as an aqueous solution on the metal band surface. Furthermore, because of their surface active properties, these substances can also be separated at very high band speeds, exceeding 500 m/min, in the form of an evenly thin film on the metal band surface.

### BRIEF DESCRIPTION OF THE DRAWINGS

The invention is explained in greater detail below using an embodiment example and comparative tests, where reference is made to the accompanying drawing. In the drawings:

FIG. 1 is a schematic representation of a band tin coating installation for the manufacture of tinplate, which allows the method according to the invention to be carried out; and

FIG. 2 is a perspective representation of a passivation device of the band tin-coating installation of FIG. 1.

### DETAILED DESCRIPTION OF THE DRAWINGS

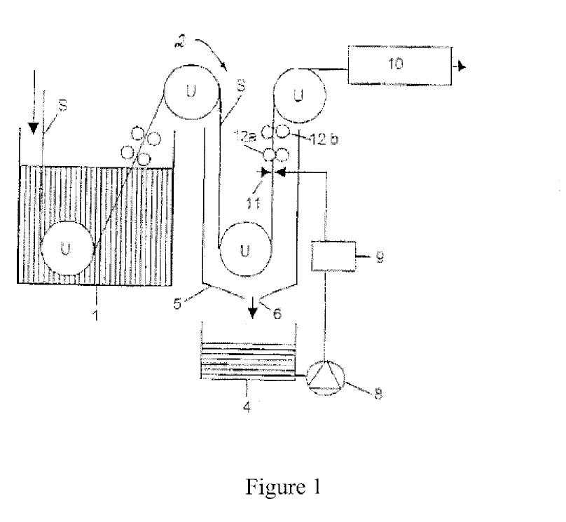

The section of the band tin-coating installation represented schematically in FIG. 1 for the manufacture of tinplate comprises an application device that is not shown in the drawing here. In the application device, the steel band S moves through a tin-coating bath and is provided in the process by electrolysis with a tin application. The steel band S for this purpose is delubricated electrolytically before the tin-coating process, rinsed with fully desalted water, and then subjected to a pickling and rinsing process with fully desalted water. The steel band S that has been cleaned in this manner then, connected as a cathode, reaches a tin-coating bath, which contains the electrolytes and the tin anodes. Under continuous monitoring and regulation of the tin-coating conditions, at a high current density, a firmly adhering, dense and uniform tin precipitation on the steel band is achieved. After the electrolysis, the tin surface is exposed to a flux after a rinsing process, that is, it is wetted in a 20-70° C. solution of 1 g/L HCl or 3 g/L zinc chloride/ammonium chloride solution, then it is squeezed off, dried and finally briefly melted inductively or by resistance heating in a melting tower to produce an optically brilliant surface of the tinplate.

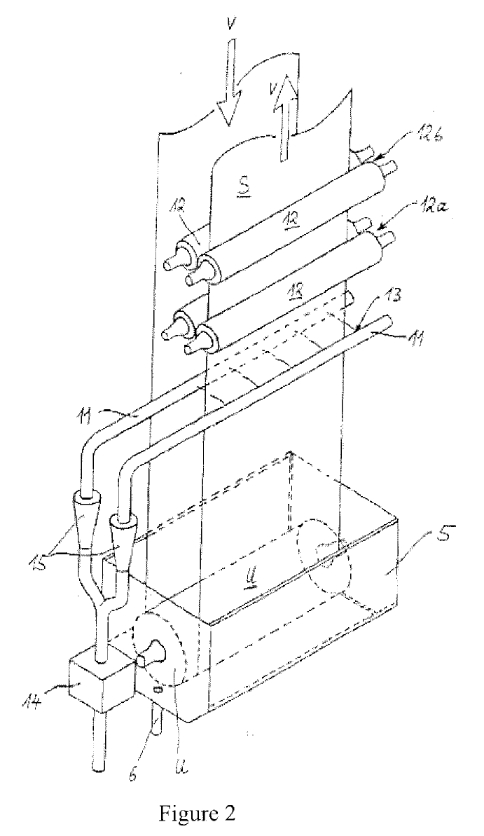

Then, the tin-coated steel band S is guided via a deflection roll U through a quenching tank 1. In the quenching tank 1, fully desalted water (FD water) is at a temperature of 70-95° C. The coated steel band S is then guided at a band speed v, typically 200-600 m/min, over the deflection rolls U through a passivation device 2. The passivation device 2 is represented in a detail, perspective view in FIG. 2.

The passivation device 2 comprises a vertical tank 5 with a downspout 6. In the vicinity of the bottom, inside the vertical tank 5, a deflection roll U is arranged, over which the coated steel band S is guided. In the upper area or over the vertical tank 5, on the two sides of the continuous steel band S, pipes 11 are arranged. The pipes 11 are parallel to each other and perpendicular or at least approximately perpendicular to the direction of advance of the band v (which here in FIG. 2 is from the bottom to the top in direction). In the pipes 11, several bores 13 are provided, arranged at a separation from each other in the longitudinal direction of the pipe. These bores 13 are opposite the continuous steel band S. The pipes 11 receive from a pump 14 a surface active substance in an aqueous solution. Between the pump 14 and the pipe inlet, a through flow meter 15 is arranged on each pipe 11.

In the direction of advance of the band v, behind the pipes 11 (that is above the pipes 11 in FIG. 2), two squeezing roll pairs 12a, 12b are arranged. The separation between the first squeezing roll pair 12a and the pipes 13 [sic; 11] in the direction of advance of the band is approximately 20-100 cm. The separation of the pipes 11 from the coated steel band S is typically 1-50 cm and preferably 5-15 cm. Each pipe 11 presents or includes at least one bore or opening, however, it is preferred—as shown in FIG. 2—for each pipe to present/include a plurality of bores in the pipe shells, arranged at a separation from each other in the longitudinal direction of the pipe. It is preferred for each pipe 2 [sic; 11] to present/include 5 bores each having a diameter of 1-4 mm, preferably 2-3 mm. However, it is also possible to use pipes having only one bore or several bores, for example, up to 50 bores.

The pipes 11 receive a surface active substance in an aqueous solution. The aqueous solution exits from the bores 13 in the pipes 11 and it impacts, in the form of liquid jets, the coated and moving steel band S. Depending on the separation of the pipes 11 from the steel band S and the position of the bores with respect to the direction of movement of the steel band S, the liquid jets impact either perpendicularly on the steel band surface or they impact the band surface at a decreasing or increasing angle. It is preferred for the separation between the pipes 11 and the steel band S to be adjusted, and for tire position of the bores with respect to the direction of movement of the steel band to be chosen, in such a manner that the liquid jets impact the steel band surface perpendicularly or at least within an angular range of ±45° C., particularly an angular range of ±15° about the normal (perpendicular) line with respect to the band surface.

Using the squeezing roll pairs 12a, 12b, which are arranged approximately 20-100 cm behind the pipes 11, seen in the direction of advance of the band, the solution that has been sprayed on the steel band surface is squeezed off so that only a layer presenting or including a few molecular layers of the aqueous solution remains, possibly only a single-molecular layer of solution, on the steel band surface.

The excess solution, and particularly the solution which has been squeezed off the coated steel band S by the squeezing rolls 12, collects in the vertical tank 5 and flows through the downspout 6 into a reservoir tank 4 arranged beneath the vertical tank 5, from which reservoir tank the aqueous solution is led by means of a pump 8 into a recovery step, where the solution collected in the reservoir tank 4 is transferred to the tank 9, in which the surfactant concentration can be increased to the target value, and finally pumped back into the pipe 11.

After the passage through the passivation device 2, the coated steel band S finally runs over a deflection roll U into a drying device 10, which consists, for example, of a hot air dryer.

In the above-described passivation device 2, tin-coated steel bands were treated with different surface active substances at different concentrations and presenting or including different compositions, and they were examined to determine their resistance to oxidation and their sliding friction factors.

The substances that are suitable for use in the method according to the invention for the passivation of the surface of tinplate must present/include surface active properties such that they can adhere to the hydrophobic group on the tin surface and at the same time, with their hydrophilic group, improve the wetting of the lacquer layer which is to be applied in the subsequent lacquering of the tin surface. The bonds between the functional group on the tin surface and the functional groups of the lacquer surface with its adhesive molecules must be so strong after the drying of the lacquer film that they are not destroyed in the cysteine test (sterilization of the lacquered tinplate for 90 min at 121° C. in a solution of 3.65 g/L KH₂PO₄ with 7.22 g/L Na₂HPO₄.2H₂O and 1 g/L cysteine). Moreover, the substances used should be soluble without the addition of organic solvents in distilled water up to a concentration of 2 g/L, because the use of solution enhancers causes concentrations that are too high of the solvent in the exhaust air and thus expensive cleaning installations are required to eliminate the solvents. Substances that have been shown to be particularly suitable are those which in practice are preferably used as additives for the improved dispersion of pigments in lacquers or to improve the crosslinking and/or the adhesion of lacquers on metal surfaces.

The following substances have been shown to be particularly suitable:

a) a polymer having a chemical composition of polymethyl siloxane with polyether lateral chains and a refractive index of 1.456-1.466 and a density at 20° C. of 1.09-1.13 g/cm³,

b) a polymer having a chemical composition of an acidic polyether with a density of 1.20-1.30 g/cm³ and an acid index of 270-310 mg KOH/g, and

c) a polymer, containing:
i) 0-80 mol % of one or more monomers of formula

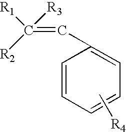

where R₁, R₂, R₃ and R₄, which may be identical or different, stand for H or an alkyl,
ii) 0-70 mol % of one or more monomers of formula

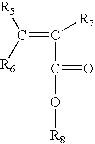

where R₅, R₆ and R₇, which may be identical or different, stand for H or an alkyl, and R₈ stands for an alkyl or substituted alkyl, and the alkyl group R₈ can be interrupted by —O groups,
iii) 5-50 mol % of one or more monomers, containing a heterocyclic group with at least one basic ring nitrogen atom, or to which such a heterocyclic group is attached after a polymerization,
iv) 0-10 mol % of one or more monomers, containing one or more groups, which are reactive for crosslinking or coupling, and
v) 0-20 mol % of one or more monomers that do not fall into groups i)-iv), where the quantity of monomers of group i) together with monomers containing an acrylate group is at least 20 mol %, as well as organic salts thereof.

These substances, in the method according to the invention, are sprayed on as an aqueous solution on the tin-coated steel band, and then optionally squeezed off and dried.

Table 1 lists several substances that in principle are suitable, and that are used in the context of laboratory tests in the method according to the invention. In the laboratory tests, ultra fine thin sheet foils were tin coated, rinsed with desalted water, and the water film was applied with a lacquer plate coating device, after which only a film with an overlay of 5 g/m² on the tinplate surface remained. Aqueous solutions of the substances indicated in Table 1 were poured at a concentration of 1 g/L on the tinplate specimen, squeezed off and then dried with warm air. The following examinations were then carried out on the tinplate specimens that had been treated in this manner:

Determination of the tin and tin oxide overlay by coulometric tin oxide determination (where the current consumed for the reduction of the tin oxide per m² is indicated in Coulomb/m²),

Determination of the sliding friction using the three-ball tracking test,

Determination of the carbon content of the sprayed on, squeezed off and dried application of the aqueous solution on the tinplate surface with a CV apparatus (company Leco), and

Storage of the treated tinplate specimens for 6 weeks at 40° C. and 80% relative humidity, and determination of the tin oxide formation after this storage.

The results of this test series are indicated in Table 1.

Sheets of a tinplate that had been manufactured according to the invention and subjected to a secondary treatment were lacquered with 5 g/m² can lacquer PPG 3907-301/A (lacquer A) or an epoxide resin lacquer (lacquer B). Examinations were carried out on these lacquered tinplate sheets to determine the resistance during sterilization, where the sterilization resistance was determined against the following substances:

3% acetic acid (100° C./30 min)

1% lactic acid+2% NaCl (121° C./30 min)

Phosphate buffer*+0.5 L/cysteine (121° C./90 min)

Phosphate buffer*+1.0 L/cysteine (121° C./90 min)

Phosphate buffer: 3.56 g/L KH₂PO₄+7.22 g/L Na₂HPO₄.2H₂O, pH 7

The results of these tests of the sterilization resistance of the tinplate sheets lacquered with the two lacquers/varnishes (A and B) are indicated in Table 2.

The tinplate specimens that were examined in the comparative tests were then examined to determine their sliding friction factor before and after the treatment according to the invention with a three-ball tracking test. Here the following sliding friction factors were determined for electrochemically passivated tinplates with a 2.9 g/m² tin overlay:

| | |
|---|---|
| without lubricant: | μ = 0.40 |
| with 4 mg/m² dioctyl sebacate | μ = 0.20 |
| (DOS, according to the usual treatment): | |

The sliding friction factors of the tinplate specimens treated with the substances according to the invention indicated in Table 1 are all reported in Table 1 and range between 0.17 and 0.46.

The tinplate specimens treated according to the invention in part present/include a considerably lowered sliding friction, compared to untreated tinplate, where, in some substances, the sliding friction factors determined were even lower than those corresponding to the usual treatment of the tinplate with DOS.

In contrast to the usual electrostatic lubrication of the tinplate surfaces with esters such as DOS, no production-related tin dust was observed with the tinplate specimens that had been treated according to the invention. On the other hand, particularly in the case of tinplate that has been lubricated with DOS using the usual method, a production-caused dust deposition is often observed, which is problematic, because it can only be eliminated by suitable, expensive treatment procedures in the installations. The reason for the absence of dust in the method according to the invention can possibly be the rinsing effect of the aqueous solution during the application or passivation, as well as the better adhesion of the tinplate on the surface of the non-driven deflection rolls in the second loop tower of the band tin-coating installations. As a result of the small amount of slip of the tinplate with the deflection roils in the loop tower, apparently no tin abrasion is produced, in contrast to lubrication with conventional substances, such as DOS.

The treatment according to the invention of tinplate furthermore reduces tin oxide growth, for example, during the storage of the tinplate or before it is lacquered. Commercial tinplate, which is manufactured and subjected to a secondary treatment using the usual methods, has the following tin oxide application after 6 weeks of storage under humid-warm conditions (40° C. and 80% relative humidity):

| | |
|---|---|
| not passivated: | 100 C/m² |
| immersion passivated: | 40 C/m² |
| electrochemically passivated: | 20 C/m² |

The tinplate specimens that had been subjected to a secondary treatment according to the invention, in contrast, present/include the values indicated in Table 1 after a corresponding storage.

From an overall view of the results of the comparative tests, one can conclude that the substances or substance classes disclosed herein, when used in the method according to the invention, for the passivation of the surface of tinplate, produce the best results with regard to oxidation resistance and sliding friction of the coated tinplate, which has been subjected to the secondary treatment according to the invention. The substances “EFKA 3580” (siloxane surfactant with polyethylene oxide chains), “EFKA 4560” (modified acrylate with polyethylene oxide chains), “EFKA 8512” and “EFKA 3570” (partially fluorinated acrylate with polyethylene oxide chains) yield the best results with regard to both properties (low sliding friction factors and low tin oxide growth).

TABLE 1
Chromium free products for treatment after coating for tin-plate surfaces, tested in the laboratory
sliding friction coefficient, product coat and tin-oxide on the past-treated tin plate surfaces

| | | | | | Sliding | CV 400° C.- | | |
|---|---|---|---|---|---|---|---|---|
| | Manufacturer | | Active substance | Active substance | friction | amount*** | Tin-Oxide C/m² | |
| No. | firm name | Product | (according to manufacturer) | (%) | coefficient | (mg/m2 C) | Org | 6 weeks |
| 1 | EFKA | EFKA 7310 | organic modified Siloxan | >95 | 0.17 | 2.9 | 34 | 88 |
| 2 | EFKA | EFKA 7315 | organic modified Siloxan | >94 | 0.17 | 2.8 | 31 | 86 |
| 3 | EFKA | EFKA 4550 | mod.Polyacrylat | 50 in Wasser | 0.18 | 3.2 | 31 | 63 |
| 4 | Tego | Glide 100 | Polyehtersiloxan-Copolymer | 100 | 0.18 | 3.0 | 39 | 77 |
| 5 | EFKA | EFKA 4580 | Polyacrylat-Emulsion | 40 in Wasser | 0.19 | 3.8 | 36 | 101 |
| 6 | Tego | Wet 280 | Polyethersiloxan-Copoymer | 100 | 0.19 | 3.8 | 31 | 68 |
| 7 | EFKA | EFKA 4560 | mod.Polyacrylat | 40 in Wasser | 0.19 | 2.8 | 34 | 63 |
| 8 | EFKA | EFKA 6225 | fat acid modified Polyester | 100 | 0.19 | 2.8 | 33 | 87 |
| 9 | Tego | Glide 450 | Polyehtersiloxan-Copoymer | 100 | 0.20 | 3.0 | 34 | 72 |
| 10 | EFKA | EFKA 3500 | fluorocarbon containing Polymer | 50 in Wasser | 0.21 | 2.8 | 36 | 116 |
| 11 | EFKA | EFKA 3570 | fluorocarbon mod.Polyacrylat | 60 in Wasser | 0.21 | 2.6 | 30 | 60 |
| 12 | EFKA | EFKA 8512 | acid Polyether | 100 | 0.22 | 2.4 | 26 | 57 |
| 13 | Tego | Dispers 752W | Copolymer + pigmentaffin.Gr. | 50 | 0.22 | 2.4 | 35 | 96 |
| 14 | EFKA | EFKA 3580 | solvent free mod.Polysiloxan | 100 | 0.23 | 2.4 | 29 | 69 |
| 15 | Tego | Dispers 750W | mod.Polymer + pigmentaffin.Gr. | 40 in Wasser | 0.23 | 2.6 | 35 | 73 |
| 16 | DOW Chem. | DOW Z 6030 | Metacrylatf.Silan | 98 | 0.24 | 3.8 | 35 | 63 |
| 17 | Tego | Glide 440 | Polyehtersiloxan-Copolymer | 100 | 0.25 | 3.0 | 38 | 78 |
| 18 | GE Silicones | A-1230 | Polyalkylenoxidalkoxysilan | keine Angabe | 0.25 | 4.0 | 28 | 67 |
| 19 | DOW Chem. | DOW Z 6137 | Homopolymer e.aminofunkt.Silans | 24 in Wasser | 0.26 | 2.9 | 30 | 47 |
| 20 | DOW Chem. | DOW Z 6040 | Epoxyfunkt.Silan | 98 | 0.27 | 2.5 | 26 | 66 |
| 21 | Wacker | HF 86 | Trlacetoxyvinylsilan | 100 | 0.30 | 3.2 | 29 | 62 |
| 22 | GE Silicones | VS-142 | Aminoalkylsilan.vorhydrolyslert | keine Angabe | 0.33 | 2.5 | 29 | 59 |
| 23 | Tego | Dispers 715W | Na-polyacrylat | 40 in Wasser | 0.34 | 2.8 | 30 | 68 |
| 24 | GE Silicones | A-187 | Glycidoxypropyltrimethoxysilan | keine Angabe | 0.35 | 2.5 | 29 | 71 |
| 25 | Wacker | Addid 911 | (3-(2,3-Epoxypropy)propyl)trimethoxsilan | 100 | 0.37 | 2.2 | 21 | 76 |
| 26 | GE Silicones | A-189 | Mercaptoporpyltrimethoxysilan | keine Angabe | 0.39 | 2.8 | 24 | 51 |
| 27 | Wacker | Addid 900 | N(3-(trimethoxysilyl)propyl-ethylendiamin | 100 | 0.41 | 3.2 | 28 | 50 |
| 28 | EFKA | EFKA 6220 | fat acid modified Polymer | 100 | 0.43 | 3.4 | 34 | 64 |
| 29 | GE Silicones | A-1110 | Aminopropyltrimethoxysilan | keine Angabe | 0.43 | 2.3 | 30 | 81 |
| 30 | EFKA | EFKA 4540 | Mod.Acrylatpolymer** | 50 in Wasser | 0.43 | 2.5 | 34 | 65 |
| 31 | EFKA | EFKA 3522 | Mod.Polysiloxanemuls.APE-frei | 35 in Wasser | 0.46 | 2.4 | 31 | 51 |

For reference: tin plate with Chromium-III-containing passivation, tinned in a production plant

| | | | | |
|---|---|---|---|---|
| dip-passivation* + 4 mg/m2 DOS** | 0.2 | 4.4 | 15 | 20 |
| electrochemical passivation* + 4 mg/m2 DOS** | 0.2 | 4.8 | 30 | 40 |

*in 25 g/l Na2Cr2O7-solution
***CV-amount measured at one-side past-treated tin-plate samples

TABLE 2
Sterilization resistance of chromium free after treated tin plate samples

| | | | Varnish adhesion in the sterilization test (cross-cut adhesion test) | | | | | | | |
|---|---|---|---|---|---|---|---|---|---|---|
| | | | Varnish (PPG 3907-301/A) | | | | Varnish B (product of a competitor) | | | |
| | Manufacturer | | 3% | 1% lactic acid + | Cystein | | | 1% lactic acid. + | Cystein | |
| Lfd.Nr. | firm name | Product | acetic acid. | 2% NaCl | 0.5 g/l | 1.0 g/l | 3% acetic acid. | 2% NaCl | 0.5 g/l | 1.0 g/l |
| 1 | EFKA | EFKA 7310 | + | + | + | + | + | + | + | − |
| 2 | EFKA | EFKA 7315 | + | + | + | + | + | + | − | − |
| 3 | EFKA | EFKA 4550 | + | + | + | + | + | + | + | + |
| 4 | Tego | Glide 100 | + | + | + | + | + | + | − | − |
| 5 | EFKA | EFKA 4580 | + | + | + | + | + | + | − | − |
| 6 | Tego | Wet 280 | + | + | + | + | + | + | − | − |
| 7 | EFKA | EFKA 4560 | + | + | + | + | + | + | − | − |
| 8 | EFKA | EFKA 6225 | + | + | + | + | + | + | − | − |
| 9 | Tego | Glide 450 | + | + | + | + | + | + | + | − |
| 10 | EFKA | EFKA 3500 | + | + | + | + | + | + | + | − |
| 11 | EFKA | EFKA 3570 | + | + | + | + | + | + | − | − |
| 12 | EFKA | EFKA 8512 | + | + | − | − | + | + | − | − |
| 13 | Tego | Dispers 752W | + | + | + | + | + | + | − | − |
| 14 | EFKA | EFKA 3580 | + | + | + | + | + | + | − | − |
| 15 | Tego | Dispers 750W | + | + | + | + | + | + | − | − |
| 16 | DOW Chem. | DOW Z 6030 | + | + | + | + | + | + | − | − |
| 17 | Tego | Glide 440 | + | + | + | + | + | + | − | − |
| 18 | GE Silicones | A-1230 | + | + | + | + | + | + | − | − |
| 19 | DOW Chem. | DOW Z 6137 | + | + | + | + | + | + | + | − |
| 20 | DOW Chem. | DOW Z 6040 | + | + | + | + | + | + | + | − |
| 21 | Wacker | HF 86 | + | + | − | − | + | + | − | − |
| 22 | GE Silicones | VS-142 | + | + | − | + | + | + | − | − |
| 23 | Tego | Dispers 715W | + | + | + | + | + | + | − | − |
| 24 | GE Silicones | A-187 | + | + | − | + | + | + | − | − |
| 25 | Wacker | Addid 911 | + | + | − | − | + | + | − | − |
| 26 | GE Silicones | A-189 | + | + | + | + | + | + | − | − |
| 27 | Wacker | Addid 900 | + | + | − | + | + | + | + | + |
| 28 | EFKA | EFKA 6220 | + | + | + | + | + | + | − | − |
| 29 | GE Silicones | A-1110 | + | + | + | + | + | + | − | − |
| 30 | EFKA | EFKA 4540 | + | + | + | + | + | + | + | − |
| 31 | EFKA | EFKA 3522 | + | + | − | + | + | + | − | − |

For reference: tin plate with Chromium-III-containing passivation, tinned in a production plant

| | | | | | | | | |
|---|---|---|---|---|---|---|---|---|
| Dip-passivation* + 4 mg/m2 DOS** | + | + | + | + | + | + | + | + |
| Electrochemical passivation* + 4 mg/ | + | + | + | + | + | + | + | + |
| m2 DOS** | | | | | | | | |

*in 25 g/l Na2Cr2O7 solution
**DOS = Dioctylsebacat
varnish adhesion good: +, corresponding Gt 0-Gt 2
varnish adhesion bad: −, corresponding Gt 3-Gt5

What is claimed is:

1. A method for the passivation of the surface of metal bands covered with a coating, particularly of tin-coated steel bands, which are moved at a band speed through a coating installation, characterized in that, after the coating process, an aqueous solution of a surface active substance is sprayed on the coated metal band moving at the band speed.

2. The method according to claim 1, characterized in that the aqueous solution of the surface active substance is then squeezed using squeezing rolls.

3. The method according to claim 2, characterized in that the coated metal band is dried after the squeezing of the surface active substance.

4. The method according to claim 3, characterized in that, after the squeezing of the surface active substance and the drying of the surface of the coated metal, a thin film of the surface active substance is present, with an overlay of 2-10 mg/m².

5. The method according to claim 1, characterized in that the surface active substance is a siloxane, particularly a polymethyl siloxane or a polyethylene oxide-containing siloxane.

6. The method according to claim 1, characterized in that the surface active substance is a copolymer, particularly an acrylate copolymer.

7. The method according to claim 1, characterized in that the aqueous solution of the surface active substance is sprayed through at least one pipe, which is arranged at a separation from the coated metal surface and includes at least one bore, through which the aqueous solution reaches the or each coated surface of the metal band.

8. The method according to claim 7, characterized in that the or each pipe includes 1-50 bores each having a diameter of 0.1-5 mm.

9. The method according to claim 7, characterized in that, on each side of the metal band, at least one pipe with bores is arranged, through which the aqueous solution is sprayed on the surface of the coated metal band, which is located opposite the bores in the pipe.

10. The method according to claims 7, characterized in that the or each pipe is arranged horizontally and at a separation of 1-50 cm from the surface of the coated metal band.

11. The method according to claim 10, characterized in that the or each pipe is arranged at a separation of 5-15 cm from the surface of the coated metal band.

12. The method according to claim 1, characterized in that the aqueous solution is sprayed in the form of liquid jets on the metal band surface(s), where the liquid jets impact on the surface of the coated metal band within an angular range from +45° to −45° with respect to the normal line.

13. The method according to claim 12, characterized in that the liquid jets impact on the surface of the coated metal band within an angular range from +15° to −15° with respect to the normal line, and preferably perpendicularly.

14. The method according to claim 1, characterized in that the aqueous solution is sprayed inside a vertical tank with a downspout for the excess surfactant solution that collects on the coated metal band in the tank.

15. The method according to claim 12, characterized in that the liquid jets impact on one of the two surfaces of the metal band in the vicinity of the area where a squeezing roll is applied to the metal band surface.

16. The method according to claim 4, characterized in that the tin overlay on the coated metal band is melted before the passivation and cooled by being led through at least one quenching tank with deionized water.

17. The method according to claim 1, characterized in that the band speed is greater than 100 m/min and preferably 300-600 m/min.

18. A device for the application of a metallic coating on a steel band, particularly a band tin-coating installation, comprising:
an application device for electrolytic application of a thin metal layer, particularly a tin layer, onto the steel band that runs through the application device at a band speed and a melting device for the tin overlay with a substance quenching tank; and
a passivation device for the passivation of the applied metal layer,
characterized in that the passivation device includes at least one pipe with a plurality of bores in the pipe shell and arranged at a separation from the coated steel band, and through which an aqueous solution of a surface active substance is sprayed onto the coated steel band that moves through the passivation device.

19. The device according to claim 18, characterized in that, on each side of the steel band, which runs through the passivation device, a pipe is arranged to spray an aqueous solution of a surface active substance on both sides of the steel band.

20. The device according to claim 18, characterized in that the passivation device includes a vertical tank with a downspout, in which tank the excess surfactant solution collects and then flows through the downspout into a reservoir tank arranged beneath the vertical tank.

21. The device according to claim 18, characterized in that, in the direction of advance of the steel band, behind the or each pipe or pipes, at least one squeezing roll pair is arranged for squeezing of the sprayed-on-aqueous solution.

22. The device according to claim 18, characterized in that the bores are arranged along the pipe at an equal distance from each other on a line that runs transversely, particularly perpendicularly, to the direction of advance of the moving steel band.

23. A method of using a substance during the manufacture of tin-coated steel bands, the method comprising:
providing the substance which includes one of:
a) a polymer having a chemical composition of polymethyl siloxane with polyether lateral chains, a refractive index of 1.456-1.466, and a density at 20° C. of 1.09-1.13 g/cm³,
b) a polymer having a chemical composition of an acidic polyether with a density of 1.20-1.30 g/cm³ and an acid index of 270-310 mg KOH/g, and
c) a polymer, containing:
i) 0-80 mol %, particularly 5-80 mol %, of one or more monomers of formula 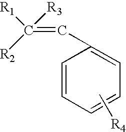
where R₁, R₂, R₃ and R₄, which may be identical or different, stand for H or an alkyl,
ii) 0-70 mol % of one or more monomers of formula 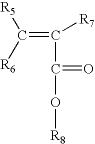
where R₅, R₆ and R₇, which may be identical or different, stand for H or an alkyl, and R₈ stands for an alkyl or substituted alkyl, and the alkyl group R₈ can be interrupted by —O groups,
iii) 5-50 mol % of one or more monomers containing a heterocyclic group with at least one basic ring nitrogen atom, or to which such a heterocyclic group is attached after a polymerization,
iv) 0-10 mol % of one or more monomers containing one or more groups, which are reactive for crosslinking or coupling, and
v) 0-20 mol % of one or more monomers that do not fall into groups A-D [sic; i)-iv)], where the quantity of monomers of group A [sic; i)] together with monomers containing an acrylate group is at least 20 mol %, as well as organic salts thereof; and
spraying the substance as an aqueous solution on the tin-coated steel bands during the manufacture of the tin-coated steel bands, wherein the substance functions as a lubrication agent and/or passivation agent.
